(19) United States
(12) Patent Application Publication
(10) Pub. No.: US 2002/0002518 A1
(43) Pub. Date: Jan. 3, 2002

(54) Communication system, communication method, server terminal, server, billing system, and billing method

(76) Inventors: Toyoshi Takahashi, Tokyo (JP); Yutuka Shigemori, Kyoto-shi (JP); Masaomi Yoshida, Kyoto-shi (JP); Akira Nakajima, Kyoto-shi (JP)

Correspondence Address: ROSENTHAL & OSHA L.L.P., Suite 4550, 700 Louisiana, Houston, TX, 77002, US

(21) Appl. No.: 09/775,097

(22) Filed: Feb. 1, 2001

(30) Foreign Application Priority Data
Feb. 3, 2000 (JP) 2000-26833

(51) Int. Cl. G06F 17/60

(52) U.S. Cl. 705/34; 705/40

(57) ABSTRACT

A communication system includes a server terminal that distributes a service program held in its possession to other prescribed terminals without the need of a server, wherein the service program possessed by the server terminal is downloaded from a server or a storage medium such as a memory card or the like, or is stored in advance in the server terminal.

### BACKGROUND OF THE INVENTION

1. Field of the Invention

The present invention relates to a communication system, a communication method, a server terminal, a server, and a billing system.

2. Description of the Prior Art

With the development of personal computer communication and the Internet, fellow personal computer users present at different locations are able to connect to host computers (servers) via various terminals to gain access to various services, including online interactive services where users can play interactive competition games and carry out conversations in chat rooms.

Now, in order to use an online interactive service, each personal computer user must first download the application program for carrying out such interactive competition game, chat room conversation or the like in advance at their respective terminal, and then execute the program to use the online interactive service. Namely, after downloading the application program, a plurality of users who are connected to host computers (servers) at the same time via networks and the like are able to play interactive competition games and carry out conversations in chat rooms by transmitting and receiving data via such servers.

However, this prior art system in which each terminal transmits and receives data via servers has the following problems. Namely, in such system, there must exist one or more fixed host computers that form the server. Further, in the case of an interactive competition game, the number of users that can connect at the same time is normally 2 to several people. Similarly, in the case of chat rooms, even though there is no specific upper limit to the number of people that can participate, the number of people connected at the same time is usually in the range of several people to several tens of people.

Furthermore, this prior art system creates problems at the server side. Namely, when there are many groups of several people who need to be connected at the same time to execute the same applications, the server needs to control the transmission and reception of data for each group.

In this case, when the number of people connected to the server forms a large number of groups, service can be interrupted when the system is down due to an overload at the server. Further, users will also not be able to receive service if the server suffers hardware or software problems.

Furthermore, in the case of an interactive competition game such as a soccer game or the like, it is necessary for the users playing the game to obtain data on the situation of opponents in real time, but the above-described prior art system of transmitting and receiving data via a server can not correspond to real time.

### SUMMARY OF THE INVENTION

It is an object of the present invention to provide a communication system, communication method, and billing system for managing server terminals and servers which makes it possible for communication to be carried out within actual groups after programs have been supplied, regardless of the state of the server.

To achieve the object stated above, the communication system of the present invention enables a plurality of terminals to receive a service program and carry out communications between terminals to execute the service program in order to receive a prescribed service. In particular, the communication system includes an agent system provided in each of the terminals, and a server terminal formed by one of the plurality of terminals, wherein the server terminal distributes copies of the service program held in its possession to other prescribed terminals via the agent system.

Further, the server terminal of the present invention includes a terminal equipped with an agent system, a communication function for communicating with other terminals, a program acquisition function for acquiring a service program, and a distribution function for distributing the acquired service program to the other prescribed terminals, whereby a prescribed service is supplied to the server terminal and the other prescribed terminals when the service program is executed by the server terminal and the other prescribed terminals.

In this regard, the service program possessed by the server terminal may be loaded by communication with another server, loaded from a storage medium such as a memory card or the like, held in advance by the server terminal, or acquired by any of various means, and so long as it is possible to receive the service program, the acquisition method does not matter. Further, the service program is a program that enables a certain service (e.g., a chat service, interactive competition game or the like) to be supplied between the plurality of terminals (including a server terminal).

Further, the terminals that received the service program from the server terminal may be equipped with a function for deleting the service program after service is terminated. However, this deletion function is not essential, and it is of course possible to arrange for the service program to be automatically saved.

Now, in accordance with the present invention, the server terminal distributes the service program to each of the terminals participating in the service. Normally, the communication carried out in the case of services such as chat services and interactive competition game services supplies service simultaneously to a plurality of groups. Accordingly, by using the structures described above, the server which supplied service in a fixed manner that formed an essential structure in the prior art can be eliminated from the communication system of the present invention, and this makes it possible to prevent service from being interrupted even when the server is down.

Further, in the case of a chat service or the like, because the server terminal supplies the service program only to those terminals within the group approved for reception, a closed service is carried out, and this makes it possible to prevent unauthorized access.

Furthermore, because there is no need for the network used with fixed servers, the present invention is also suited to interactive competition games that require real-time acquisition of the situation of opponents, and the present invention also expands the types of applications service programs can be used for.

Further, the server of the present invention includes an agent system capable of supplying a service program to a prescribed terminal, and an information transmission function which transmits information related to the service program to the prescribed terminal at the time the service program is supplied thereto, wherein the transmitted information makes it possible for the prescribed terminal to distribute the supplied service program to other terminals. In this regard, the information that enables distribution may include, for example, information related to the number of terminals approved to receive the service program.

In this regard, in the embodiments of the present invention, the “information” that makes it possible to distribute the service program to the other terminals can be a distribution approval number, and in the case where the service program can be supplied with only a number that enables distribution, the program itself forms the information. In short, the information may be any data that makes it possible for the terminal (server terminal) that received the service program to distribute (transmit) such service program to the other terminals. Further, in addition to specifying the distribution number, this information may specify other conditions, such as the usage time interval. In this way, by specifying the distribution approval number, it is possible to prevent the server terminal from supplying the service program to an unlimited number of terminals.

In this connection, the information (distribution approval number) that makes it possible to distribute the service program to the other terminals may be determined in advance at the server side. Further, this information may be determined in accordance with a request from the server terminal. For example, in the case where the service program is a game, because the number of people able to use the service program at the same time is frequently determined in advance, the information enabling distribution may be determined based on such number of people, or a fixed distribution approval number can be established independently without regard to the service program. Further, in the case where the number of participating people can be freely established when there are no problems with the device capacity and the like, such as when a chat service is used, the distribution approval number may be established in accordance with a request from the server terminal.

Further, in another embodiment of the present invention, the server is equipped with an agent system capable of supplying a service program to a prescribed terminal, and the service program includes a server function program which makes it possible for the prescribed terminal receiving the service program to function as a server.

In this way, in the case where a terminal that does not have a server terminal function wants to become a server terminal, such terminal can receive the service program that includes the server function program, and then by executing the server function program, the terminal can function as a server terminal. In this regard, the server function program may be stored together with the service program for receiving the prescribed service (carried out by communication between the plurality of terminals), or the service program can be configured with a server function program element.

Further, the present invention includes a billing system for carrying out a billing of a service program supplied from a server to a server terminal and then distributed to other terminals. In a first embodiment of this billing system, a billing function is provided in the server terminal to carry out a billing of all distributed service programs based on information related to the number of terminals approved to receive the service program sent from the server to the server terminal.

In this way, because the server can carry out a billing of the service program supplied to the server terminal and the service programs distributed to the other terminals from the server terminal based on the terminal approval information, the management operations required for such billing are simple, and this makes it possible to reduce as much as possible the risk that payment can not be collected.

Further, in another embodiment of the billing system of the present invention, each of the terminals is provided with a reception notification function to directly notify a billing server that the service program was received from the server terminal, whereby a direct billing is carried out when the service program is distributed from the server terminal to the other terminals.

In this regard, the billing server is a site for paying bills issued in accordance with the reception of service programs by terminals. For example, in the case where the server terminal receives a service program from a certain server, such server can form the billing server. However, the server that supplies the service program does not necessarily have to be the billing server, namely, it is possible to provide a separate billing server. In particular, a billing server is necessary in the case where the service program is not supplied from a server, such as when the service program is executed via a memory card or other storage medium, or when the server terminal is provided with the service program in advance.

For example, when there is a large number of terminals capable of receiving the service program from the server terminal, if a billing of all the service programs distributed to the terminals is carried out at the server terminal, such bill can become quite large, and this will create a large burden on the server terminal. Further, there is also the case where the number of terminals that will actually use (be supplied with) the service program is smaller than the distribution approval number. In such cases, it would be unfair for the server terminal to carry out a billing for the terminals that do not use the service program, and in the case where only the actual number of terminals is used for billing each time a request is sent to the server, the server can be assumed to carry the burden. Further, when there are terminals that do not execute the program, it is safe to assume that no actual loss will result when billing is not carried out for such non-use terminals.

In this regard, instead of carrying out a billing for the other terminals based on the distribution approval number, the server terminal can carry out a billing at the actual distribution time for the terminals that receive the service program, and this makes it possible to reduce the financial burden on the server terminal. Further, if the terminals are provided with an agent system that automatically executes programs, then by having the terminals automatically send a reception notice to the billing server when a service program is received, it becomes possible to carry out reliable billing. Further, if billing is carried out regularly (e.g., by having the billing server contact the terminals) as a condition for executing the service program, then it is possible to prevent the execution of the service program by user's who try to obtain the program in an unauthorized manner in order to avoid paying fees, and this makes it possible to prevent unauthorized access to the service.

In this connection, each of the means and functions that make up each of the apparatuses of the present invention can be achieved by an exclusive-use hardware circuit, or by a programmed computer.

### BRIEF DESCRIPTION OF THE DRAWINGS

FIG. 1 is a drawing showing a preferred embodiment of the communication system according to the present invention.

FIG. 2 is a drawing showing the internal structure of the server.

FIG. 3 is a drawing showing one internal structure of the server terminal.

FIG. 4 is a drawing showing another internal structure of the server terminal.

FIG. 5 is a drawing showing the internal structure of a terminal.

FIG. 6 is a flow chart used for describing the function of the server.

FIG. 7 is a flow chart used for describing the function of the server terminal.

FIG. 8 is a flow chart used for describing the function of a terminal.

FIG. 9 is a flow chart used for describing the function of the server terminal.

FIG. 10 is a flow chart used in describing the function of a terminal.

### DETAILED DESCRIPTION OF THE PREFERRED EMBODIMENTS

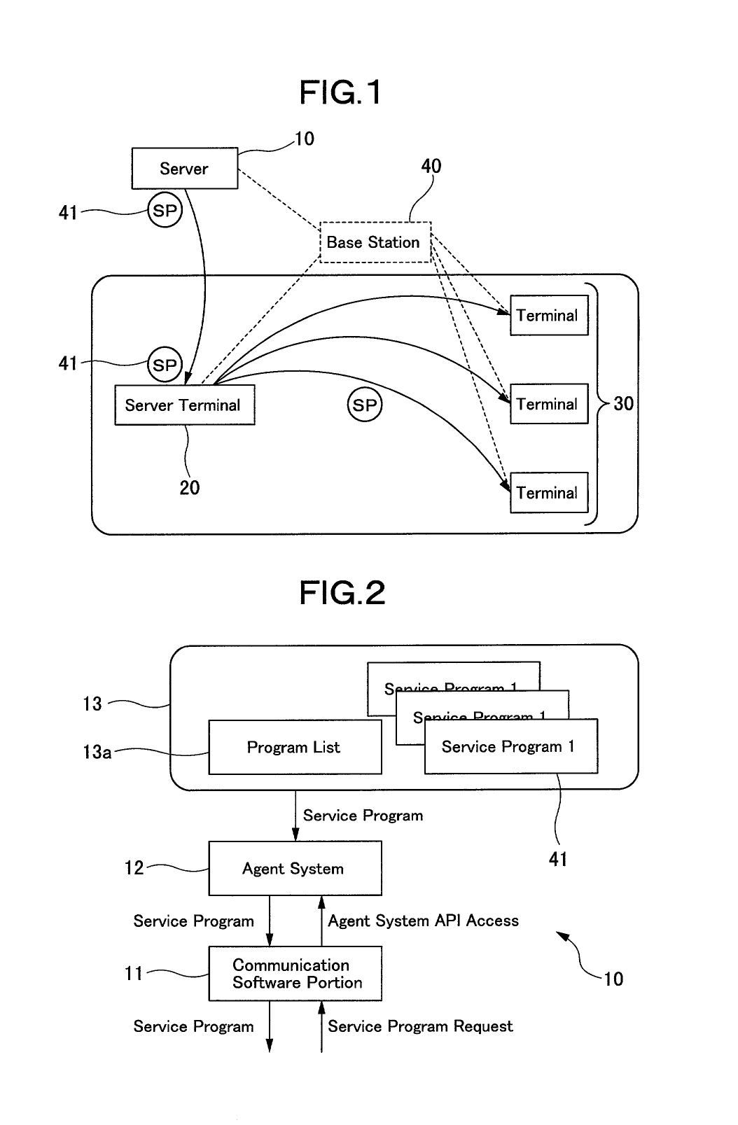

FIG. 1 shows a preferred embodiment of the present invention. As shown in this drawing, a service program 41 that enables users (terminals) to participate in a chat service or play interactive competition games while simultaneously carrying out communication is stored at a server 10, and this service program 41 is transmitted from the server 10 to a prescribed terminal where a request has been made. In the present embodiment, the terminal receiving the service program 41 transmitted from the server 10 is designated as a server terminal 20.

Now, in the present invention, the service program 41 is distributed not by the server 10 but by the server terminal 20 to the plurality of terminals 30 that form the group that will simultaneously execute the service program 41. This is the first special feature of the present invention.

Further, after the service program 41 is sent to the server terminal 20 and then distributed to the one or more terminals 30 by the distribution system described above, prescribed operations are carried out in the group comprised of the server terminal 20 and each of the terminals 30 using the service program 41. When this service program 41 is being carried out in the present embodiment, the terminals 30 are connected to the server terminal 20 but are not connected to the server 10, and in this arrangement data is transmitted and received between the server terminal 20 and the terminals 30 and between one terminal 30 and another terminal 30. In other words, the function (i.e., transmission and reception of data between terminals) performed by the server 10 in the prior art is carried out by the server terminal 20 in such group.

In this way, the server 10 only needs to transmit the service program 41 to the server terminal 20. Accordingly, after distribution, because the service program 41 is executed within the group comprised of the server terminal 20 and the terminals 30 independently of the server 10, the load on the server 10 can be greatly reduced, and this makes it possible to carry out communication within the group regardless of the state of the server 10. Further, because the server terminal 20 operates as a server for only a limited number of terminals 30, the load placed on the server terminal 20 is not that large, and this makes it possible to carry out operations smoothly.

In this connection, the server terminal 20 is a portable terminal which uses a portable phone, PHS, PDA or other portable communication technology to communicate with the server 10 via a wireless base station in order to transmit and receive data. Further, the terminals 30 are portable terminals similar to the server terminal 20, and the terminals 30 also communicate with the server terminal 20 via the wireless base station in order to transmit and receive data.

Further, when the service program 41 is being transmitted from the server 10 to the server terminal 20, the server 10 also transmits information related to the distribution approval number which sets the number of terminals 30 allowed to receive the service program 41. Then, the service program 41 received by the server terminal 20 is distributed only to the approved number of terminals 30.

Now, in the case where the distribution service described above for distributing the service program 41 is a business, it can be assumed that a billing is carried out at the time of such distribution or at fixed time intervals until the dissolution of a contract for receiving distribution. In this case, it is possible for the server terminal 20 to distribute the service program 41 to an unlimited number of terminals 30. Consequently, if the terminal that receives the service program 41 can function as a server terminal, the person managing the server 10 which is capable of unlimited distribution of the service program 41 can only obtain a billing of transmissions to the first server terminal.

To deal with this problem, a distribution approval number is established in the present embodiment to set the number of terminals 30 allowed to receive the service program 41, and in this way the service program 41 is only distributed to terminals 30 identified by the distribution approval number. Then, using a value based on the function of the service program 41, the server 10 can carry out a billing based on the distribution approval number, and this makes it possible to conduct business.

In this regard, the distribution approval number may be determined in accordance with a request from the server terminal 20, or in the case where the number of terminals 30 that will simultaneously execute the service program 41 is determined in accordance with the content of the service program 41, the distribution number may be determined in advance. Namely, in cases where the number of terminals 30 that will simultaneously execute the service program 41 can not be specified, such as in the case of a chat service, a request from the server terminal 20 is required to determine the distribution approval number, but in cases where the number of terminals can be specified, such as in the case of interactive competition games, the distribution approval number can frequently be determined in advance from the rules of the game that set the number of people allowed to play at the same time. Accordingly, in the latter case, the number of allowable players may be used as the distribution number in the initial establishing step. For example, in the case of the game Mah Jong, because up to four people are able to play, the distribution approval number will be 3, while in games that have two opponents, the distribution approval number will be 1.

Now, in the example shown in the drawings, the server terminal 20 and the terminals 30 comprise a network via the wireless base station 40 to carry out the transmission and reception of data. However, it should be noted that the present invention is not limited to this arrangement, and it is possible to use any appropriate configuration. Further, the transmission medium may be either wireless or wirebased.

Furthermore, the service program 41 is an agent that carries out automatic execution autonomously. In this case, an agent system operates in the server 10, the server terminal 20 and the terminals 30 described above.

In this connection, the agent is equipped with a function to automatically execute programs at a moving site, and the principle (process) of such automatic execution is described below. Namely, the agent system has an agent transmission-reception portion for transmitting and receiving agents, and when an agent that has been transferred in is received via this transceiver portion, the agent system restores the received agent to a state in which execution can be carried out. Further, this restored agent includes an automatic execution portion and a normal execution portion. The automatic execution portion carries out a program initialization setup, a system setup and the like immediately after downloading, and the normal execution portion carries out the actual service (i.e., the original program required by the user), which includes the case of supplying data.

Next, the automatic execution portion of the agent system carries out the automatic execution of the transferred and restored service program 41. In this way, the service program 41 is executed automatically by the agent without receiving execution commands from the user. Further, in the case where an execution command for the normal execution portion is also present in the automatic execution portion process, then automatic operations will be continued for the normal execution portion.

Next, specific structures of various devices for carrying out the processes mentioned above will be described below. First, the internal structure (software structure) of the server 10 is shown in FIG. 2. Namely, the server 10 is equipped with a communication software portion 11 for transmitting and receiving data in accordance with a prescribed communication protocol, an agent system 12 for managing the transmission and reception of agents, the execution of agents and other operations involving agents, and a service program storage portion 13 for storing the service program 41.

The communication software portion 11 provides a general communication function of a TCP/IP or the like. The agent system 12 is designed to receive service program requests received via the communication software portion 11, and then transmit the corresponding service program to the transmission source of the request. In other words, in addition to having an agent (service program 41) transmission-reception function (i.e., a transmission function in relation to the present embodiment), the agent system 12 is also equipped with a search function for searching the service program 41 corresponding to a received request, and a transfer function (where the transfer itself is a transmission function) for pulling up and transferring the searched service program 41.

Further, when the service program 41 is being transferred (supplied), a process in accordance with the distribution approval number is carried out. For example, in such process, when the distribution approval number is known, if the integer 1 is subtracted from the distribution approval number each time the server terminal 20 distributes (transfers a copy of) the service program 41 to one of the other terminals 30, then it is possible to prevent any further distribution after the distribution approval number reaches “0”. Namely, because the service program 41 is supplied to the server terminal 20 and then distributed from the server terminal 20 to a number of terminals 30 equal to the distribution approval number, the number of times the service program 41 is supplied will be equal to “distribution approval number +1”. Moreover, the process related to the distribution approval number can carry out various other specific processes.

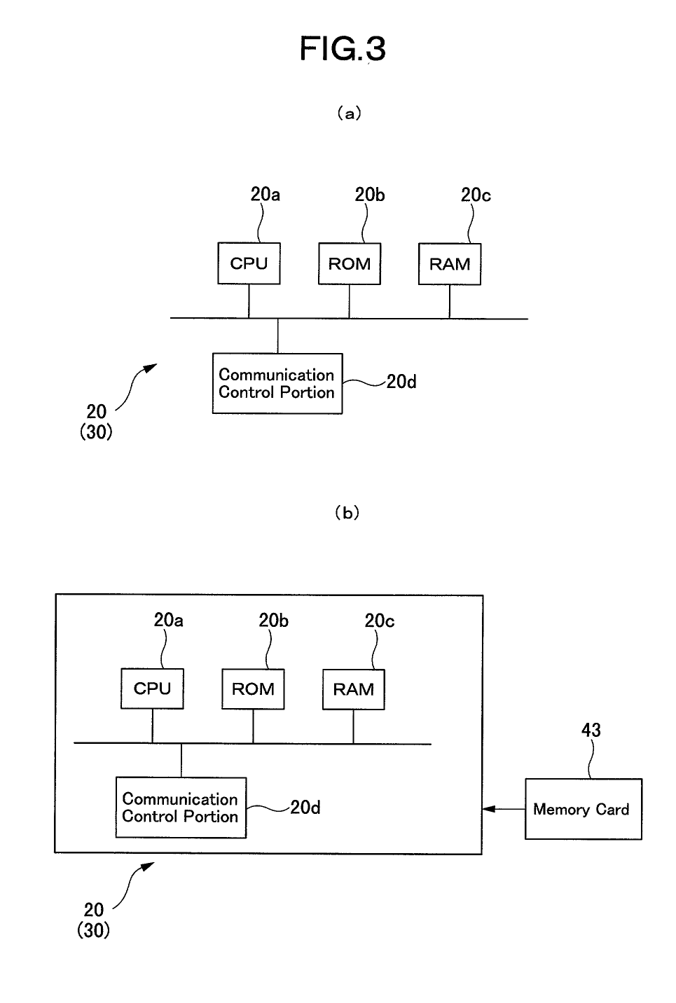

Next, as shown in FIG. 3(a), the hardware structure of the server terminal 20 is equipped with a CPU 20a for carrying out various control processes, a ROM 20b for storing terminal exclusive-use software and agent systems, a RAM 20c used when executing the downloaded service program and the like, and a communication control portion 20d for controlling the communication with the server 10 and with the other terminals 30. As is clear from the drawings, the hardware structure is similar to a general terminal.

Further, as shown in FIG. 3(b), in the case where a memory card 43 can be installed in the portable terminal capable, the service program 41 can be stored in such memory card 43 for later use, and then the service program 41 can be supplied to such portable terminal by inserting the memory card 43 into the portable terminal, whereafter the portable terminal can carry out the service program 41. In this case, when the service program 41 is to be executed, the service program 41 stored in the memory card 43 can be transferred to the ROM 20b, RAM 20c and the like of the server terminal 20, or the service program 41 can be utilized while it remains in a stored state in the memory card 43.

In other words, in the present invention, the service program 41 may be supplied to the server terminal 20 by downloading (agent transfer) from the server 10, or by using any of various storage mediums existing separate from the server 10 such as a memory card 43 or the like.

Furthermore, the service program 41 does not have to be supplied from the outside. Namely, it is also possible to load the service program 41 into the ROM 20b and the like of the server terminal 20 in advance. Further, the hardware structures shown in FIG. 3 may also be used for the terminals 30.

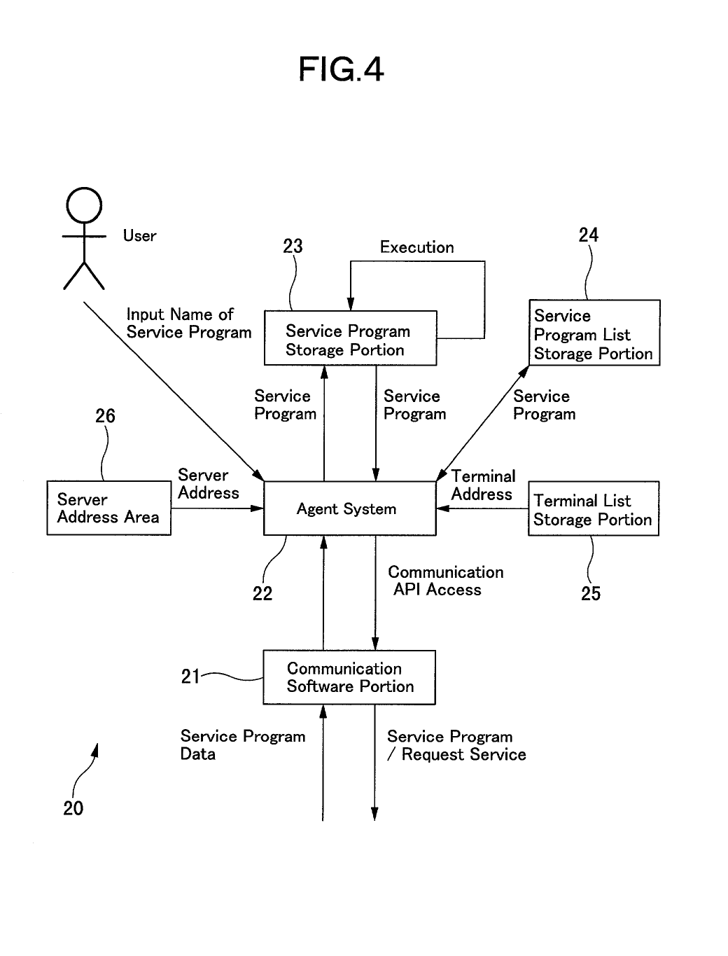

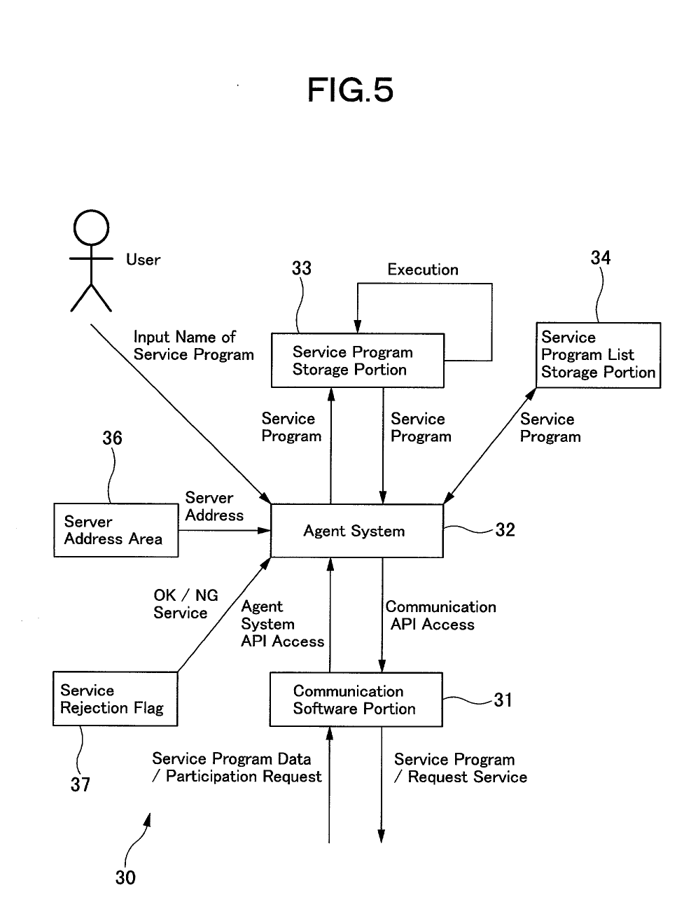

Next, FIG. 4 shows an example of the software structure of the server terminal 20 having the hardware structure described above. Namely, the server terminal 20 is equipped with a communication software portion 21 for transmitting and receiving data in accordance with a prescribed communication protocol, an agent system 22 for managing the transmission and reception of agents, the execution of agents and other operations involving agents, and a service program storage portion 23 for storing the service program 41.

The communication software portion 21 provides a general communication function of a TCP/IP or the like. The agent system 22 is designed to receive service program requests received via the communication software portion 21, and then transmit the corresponding service program to the transmission source of the request. In other words, in addition to having an automatic execution function and a transmission-reception function for the agent (service program 41), the agent system 22 is also equipped with a function for issuing a service program supply request to the server 10 to request the service program 41 required (i.e., to be utilized by) the server terminal 20.

Namely, a server address area 26 is accessed to acquire the server address stored in such area. Then, with such acquired server address set as the transmission site, a service program supply request is made. For example, this supply request may first request that a list of the service programs held by the server 10 be supplied, and after the server 10 processes such request, the list sent from the server 10 is outputted and displayed on a display portion of the server terminal 20. Then, information (number, program name or the like) indicating the service program selected from such list by the user is sent to the server 10 together with a supply request for such selected service program.

Further, in the case where a list related to the service programs that will be supplied and the servers that store them is stored in the server address area 26, instead of issuing the supply request for the list described above, the user inputs information specifying the service program that will be utilized. In this case, the agent system 22 that receives such information can be arranged to access the server address area 26 to acquire the server address of the server supplying such service program, and then issue a supply request to such acquired server address.

Further, because the requested service program will be transmitted in from the server 10, the agent system 22 includes a function for receiving and restoring such service program, and then storing the restored service program in the service program storage portion 23. At this time, information related to the received service program, namely, the name of the service program, the distribution approval number and the like are stored in a service program list storage portion 24. In this way, the service programs held by the server terminal 20 can be identified by accessing the service program list storage portion 24. Further, in the case where the received service program is to be executed, such execution is carried out by the agent system 22.

Furthermore, in the case where the service program is not supplied from the server 10, but is instead stored in advance in the ROM 20b, the memory card 43 or the like and then retrieved therefrom, as shown in FIG. 3(b), because there is no need to issue a supply request notice to the server 10 described above, it is possible to omit the function for carrying out the processes for supplying programs from such server 10. Accordingly, the server address area 26 may also be omitted.

Further, the server terminal 20 needs to distribute the received service program to the other terminals 30, and this is achieved by equipping the agent system 22 with a distribution function. Namely, the distribution site addresses stored in a terminal list storage portion 25 (e.g., a memory or the like for storing the phone numbers of the other terminals in the case where a portable phone system is utilized) are accessed, and then the service program 41 supplied from the server 10 is distributed to the terminals at such distribution site addresses.

In this regard, the function for distributing the service program 41 to the terminals 30 can be carried out various ways. For example, the service program 41 may be automatically distributed from the server terminal 20 to the terminals 30 listed in the terminal list stored in the terminal list storage portion 25 described above, or such distribution may be carried out in accordance with requests (service program supply requests) from the terminals 30.

Further, the server terminal 20 is also equipped with a server function which carries out data transmission and reception with each of the terminals 30, and which simultaneously executes the service program within the group after the service program has been distributed from the server terminal 20 to the terminals 30. This server function can be provided in the server terminal 20 in advance by equipping the agent system with such server function, or by storing a separate server function program in the ROM or the like. Further, instead of providing the server function in advance, a server function program which enables a terminal to carry out the server function can be stored at the server 10 side, and then when a terminal wants to become a server terminal, the server function program can be downloaded, or in the case where both a service program that includes the server function program and a service program that does not include the server function program are prepared in advance, the terminal that wants to become a server terminal can download the service program that includes the server function program.

In this connection, FIG. 5 shows the internal structure of one of the terminals 30. Namely, the terminals 30 is equipped with a communication software portion 31, an agent system 32, a service program storage portion 33, a service program list storage portion 34, a server address area 36, and a service rejection flag 37. As is clear from a comparison of FIGS. 5 and 4, the terminal 30 has the same basic structure as that shown in FIG. 4, but due to its designation as a terminal 30, the structure shown in FIG. 5 has no need for the server function described above. Further, because the terminal 30 does not distribute the service program 41, there is also no particular need for the terminal 30 to be provided with a terminal list storage portion 25. Further, the server address area 36 can be used, for example, to store the address of the server terminal, for example.

Further, in the present embodiment, the terminal 30 has a service rejection flag 37, and when this flag is ON, the supply of service (reception of the service program) is rejected. In this way, for example, in the case where a participation request notice is sent from the server terminal 20 to the terminal 30 regarding the distribution of a service program, if the terminal 30 is currently in a state where it is unable to receive and execute the service program, then by raising (turning ON) the service rejection flag, it becomes possible to reject automatic downloading of the service program to such terminal 30.

In the present embodiment, the service program is the agent, and because the service program is automatically transferred and executed by the agent systems 22, 32, the service rejection flag 37 described above is utilized to prevent such automatic execution in advance. However, it should be noted that this service rejection flag 37 may be omitted from the terminal 30.

Further, even though the server terminal 20 and the terminal 30 were described using FIG. 4 and FIG. 5, respectively, when considering simultaneous execution in the case where actual portable terminals are used in the distribution system and in the plurality of terminals (including the server terminal) described above, at a certain point in time the portable terminal that became the server terminal 20 for one group will become a terminal 30 in another group. Accordingly, in actual practice, the portable terminals should preferably have both of the functions shown in FIGS. 4 and 5.

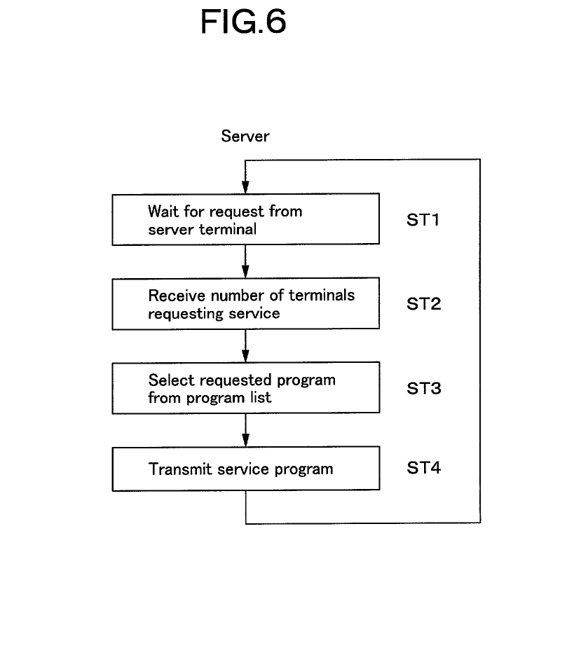

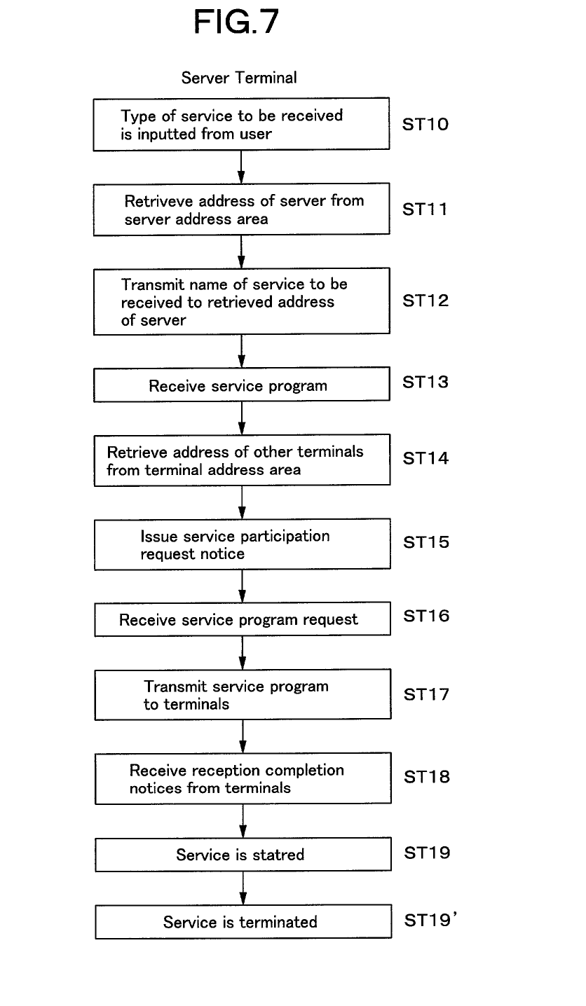

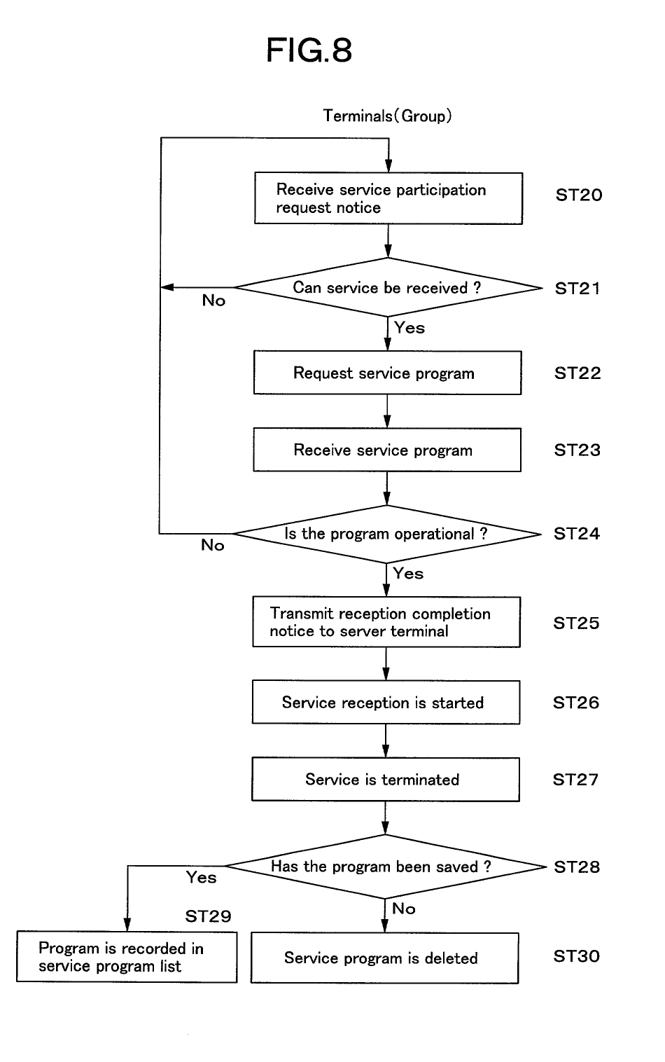

Next, the specific process function of each of the above apparatuses will be described with reference to FIGS. 6˜8 which are flow charts describing the functions of the server 10 (FIG. 6), the server terminal 20 (FIG. 7) and the terminals 30 (FIG. 8) used to achieve the system for distributing the service program supplied to the server terminal 20 from the server 10. In this connection, the server terminal 20 and the terminals 30 have a hardware structure like that shown in FIG. 3(a).

First, as shown in FIG. 6, the server 10 first waits for a program supply request from the server terminal (ST1). Then, when such supply request notice (service program name+utilization terminal number) is received, the agent system 12 examines a program list 13a and then selects the requested service program (ST2, ST3). In other words, the address or the like where the service program 41 is stored in the service program storage portion 13 is acquired, and then such service program 41 is read out (ST4).

Then, this read-out service program 41 (actually a copy thereof) is transmitted to the server terminal 20 that made the request. At this time, distribution approval number information for approving the number of other terminals requesting use of the service program 41 is transmitted together with the service program 41. After that, the process described above is repeatedly carried out. As can be understood from this arrangement, after transmitting the service program one time, the server 10 does not participate in the execution of the program carried out by the server terminal 20 and the terminals 30. Accordingly, because the server 10 only needs to supply the service program 41 to the service server terminal 20, the load placed on the server 10 is reduced.

Next, as shown in FIG. 7, after the server terminal 20 acquires information related to the service program 41 that the user has inputted a request for, the server address area 26 is accessed based on such information, and then the address of the server 10 supplying the corresponding service program is retrieved (ST10, ST11).

Next, the name of the service program that needs to be supplied and the utilization terminal number are transmitted to the retrieved address of the server 10 (ST12). After receiving the transmitted supply request, the server transmits the requested service program, which is then received by the server terminal 20 (ST13). In other words, the agent system 22 receives and restores the service program 41 to enable utilization within the server terminal 20. The process up to this point forms the reception function.

After that, the terminal list storage portion 25 is accessed to acquire the addresses of the other terminals 30 that will simultaneously execute the acquired service program 41 (ST14). Then, a service participation request notice is issued to the retrieved terminal addresses (ST15). Now, in the case where each of the terminals 30 that received the service participation request notice will participate (as described below), because the service terminal 20 will receive participation requests (i.e., service program requests) transmitted from such terminals 30, the service terminal 20 will transmit the service program 41 to these terminals 30 (ST16, ST17).

Then, in the case where the transmission of the service program 41 is successfully carried out, because a reception completion notice will be issued from each terminal 30, the server terminal 20 will receive such reception completion notices (ST18), and then service will be started (ST19). Namely, the transmitted service program 41 is simultaneously executed by the server terminal 20 and the terminals 30 while communication is carried out between all these terminals.

Now, as shown in FIG. 8, when a terminal 30 receives a service participation request notice from the server terminal 20 at Step 15 (ST20), a judgement of whether or not the terminal 30 is in a state capable of receiving the current service is carried out (ST21). Namely, when the service rejection flag 37 is in an ON state, reception is judged to be impossible, but when the service rejection flag 37 is in an OFF state, reception is judged to be possible. In this connection, there are many situations in which reception is not possible, such as when a separate service is currently being executed, when a phone call is being made from the terminal, when the user is carrying out another operation, or when the user is not present. In this regard, the service rejection flag 37 can be automatically switched ON and OFF in accordance with the operating state of the terminal 30 or in accordance with manual inputs from the user.

In the case where service can be received, the terminal 30 transmits a service program supply request to the server terminal 20 (ST22), and then the requested service program 41 transmitted from the server terminal 20 is received by the terminal 30 (ST23). At this point, the service program 41 (agent) is normally restored, and then once the service program 41 is restored to an operational state, a reception completion notice is transmitted to the server terminal 20 (ST24, ST25).

After that, the received service program 41 is executed, and while data is being transmitted to and received from the server terminal 20, service is received in accordance with the execution of the service program 41 by the server terminal 20 and the other terminals 30 (ST26). Then, when such service is terminated, a judgement of whether or not the received service program has been saved is carried out, and in the case where it has not been saved, the stored service program that was restored is deleted. On the other hand, in the case where the service program 41 has been saved, the name of the stored service program 41 is recorded in the service program list storage portion 34 (ST27˜29).

Further, in the case where the service program name is recorded in this way, if the same service program is to be executed again at a later time with the same server terminal 20, then instead of receiving the service program 41 again from the server terminal 20, the service program 41 (agent) already stored in the terminal 30 is executed, and service is started again. Namely, Steps 22˜24 are skipped. In other words, although omitted from the drawings, a judgement process (process for searching the service program list) for judging whether or not the service program that received a service participation request notice is already stored is provided before Step 22, and in the case where such service program is already stored, the corresponding service program is selected and the process skips to Step 25, but in the case where such service program is not already stored, a process for skipping to Step 22 is needed.

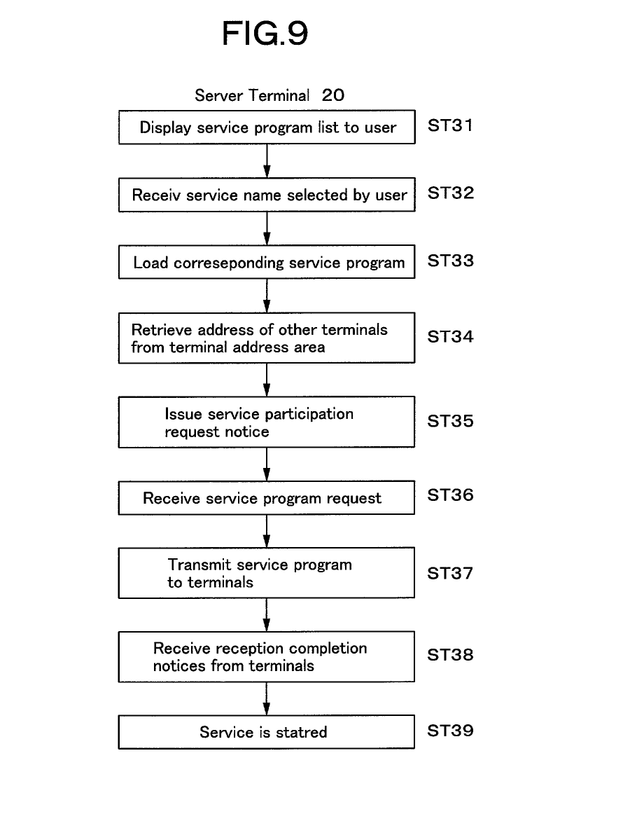

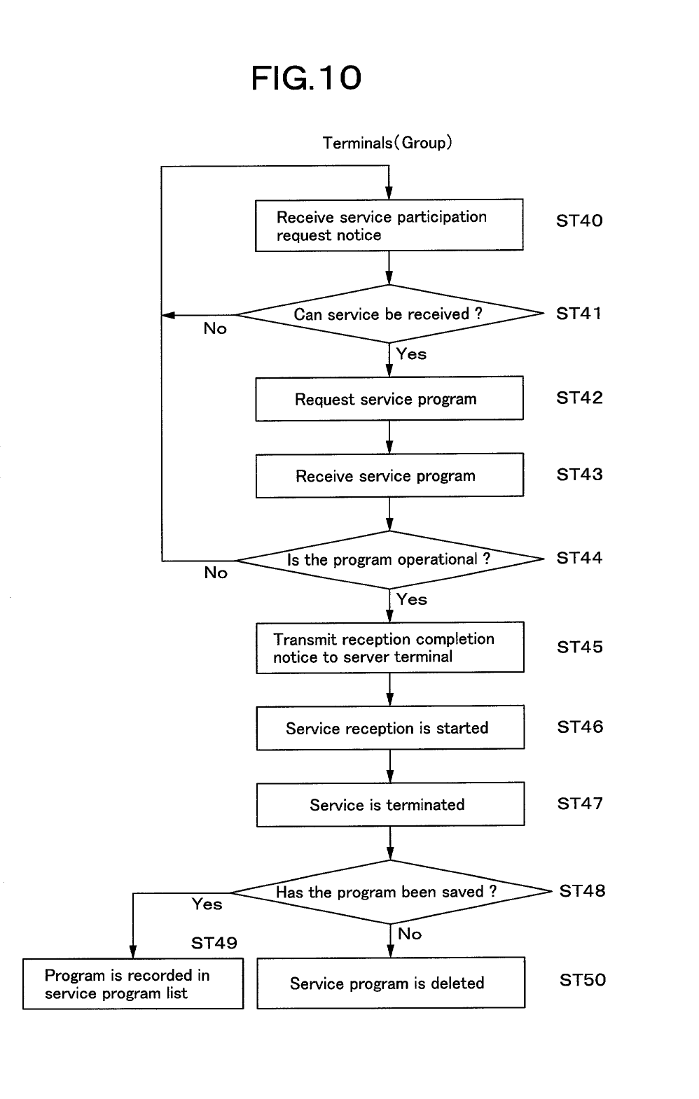

On the other hand, in the case where a system in which the existence of a server is not a prerequisite is employed, the server terminal 20 carries out the process functions shown by the flow chart of FIG. 9, and the terminals 30 carry out the process functions shown by the flow chart of FIG. 10.

First, as shown by FIG. 9, a service program list of the service programs held by the server terminal 20 is displayed for the user (ST31). Namely, because service programs are already stored in the ROM 20b, RAM 20c, memory card 43 (in the case of the server terminal structure shown in FIG. 3(b)) or the like, and because the names of such service programs held by the server terminal 20 are stored in the service program list storage portion 24, the server terminal 20 can read out such service program list and display it on a monitor.

Then, because the service program to be utilized by the user is selected from the list displayed on the monitor, after a selection is received, the corresponding service program can be loaded and executed (ST32, ST33).

Next, the terminal list storage portion 25 is accessed to retrieve the addresses of the other terminals 30 that will simultaneously execute the acquired service program (ST24). Now, because the process steps ST35˜ST39 (i.e., the exchange of data with the terminals 30) that follow are basically the same as the process steps ST15˜ST19, a detailed description thereof is omitted.

Next, the process carried out by the terminals 30 shown in FIG. 10 is basically the same as the process shown in FIG. 8. Further, it is also possible to use a memory card or the like to transfer the service program 41 from the server terminal 20 to the terminals 30. In other words, the memory card 43 stored in the server terminal 20 can be temporarily removed and then inserted into a terminal 30. In this regard, because information such as the address of the server terminal 20 is also stored in advance on the memory card 43, the server terminal address is transferred together with the service program 41 (copy) to the terminal 30. In this way, the series of process Steps 40˜44 may be omitted or carried out at the terminal 30 side. Then, the process following from Step 45 is carried out via communication between the terminal 30 and the server terminal 20.

Further, this arrangement in which data is exchanged only between the server terminal 20 and the terminals 30 also applies, for example, to the case where a received service program supplied previously to the server terminal 20 from the server 10 is saved for later use. In other words, in the case where the server terminal 20 that carries out the series of process steps in FIGS. 6 and 7 to receive the supplied service program temporarily suspends service, the next time this same service program is to be started, the server terminal 20 may execute such service program in accordance with the process flow shown in FIGS. 9 and 10.

Further, the process flow from FIG. 6 through FIG. 8 and the process flow in FIGS. 9 and 10 do not have to be carried out continuously. Instead, such processes can be temporarily suspended at any point in time, after which the processes can be restarted from the suspension point or the like.

Next, an example of an actual application of the above-described system that uses a service program will be described. First, when the service program 41 is a chat service program, the user who will use the server terminal 20 operates his or her own terminal 30 (i.e., a portable phone, PDA or the like) to send a request for such chat service program 41 to the server 10. In the case where this chat service program 41 is possessed in advance, execution is carried out in accordance with the processes shown in FIGS. 9 and 10. This is the same for the example given below.

Then, the server 10 transmits the chat service program 41 to the server terminal 20. Next, the server terminal 20 transmits the received chat service program 41 to the terminals 30 listed in advance in the terminal list storage portion 25. Then, the agent system 32 of each terminal 30 operates the chat service program 41 supplied from the server terminal 20, and the chat service is started.

In this system, because the side supplying the service (i.e., the server terminal 20) selects parties (terminals 30) that will participate in the service, it is possible to operate a secure chat service. Namely, a secure chat service is possible due to the fact that the side supplying the service issues a participation request notice only to those terminals wanting to participate. In contrast with this, prior art chat services do not select the participants for the chat service, and this creates various operating problems, such as when a participant with bad intentions participates in the chat service. However, these problems are eliminated by the present invention.

Now, when the service program 41 is an interactive competition game service program, the user who will use the server terminal 20 sends a request for such interactive competition game service program 41 to the server 10. After receiving such request, the server 10 transmits the interactive competition game service program 41 to the server terminal 20, and then the server terminal 20 transmits the interactive competition game service program 41 received from the server 10 to prescribed terminals 30. Then, the agent system of each terminal (including the server terminal 20) operates the interactive competition game service program 41 to start the interactive competition game service. In this connection, the interactive competition game service program 41 loaded into the server terminal 20 does not have to be supplied from the server 10, and it is possible to use various loading methods, including the loading method that uses a memory card like that shown in FIG. 3(b), for example.

When this is done, the events occurring at each terminal (including the server terminal) must be transmitted to each of the other terminals. In the case where the operation protocol is TCP/IP, for example, a closed network can be formed by recording the IP of each terminal in a multi-cast list, and this makes it possible to play games without increasing traffic on the network that connects the terminals.

Furthermore, in the case where the service program 41 is a role-playing game that allows a plurality of players to participate in real time (i.e., a real-time simultaneous-play RPG), it is possible to carry out the process described below. Namely, in the same manner as in each of the examples described above, the game program is first downloaded by one user at a server terminal 20 from the server 10, and then the downloaded game program is distributed to the other terminals 30. Then, each of the users that use the server terminal 20 and the terminals 30 selects his or her own game character to participate in the service (game).

At this time, because the plurality of terminals (including the server terminal) execute the same service program, each of the users operating each terminal will be able to post his or her game character on the same map in real time, and in this way the game can be played in real time.

Then, for the supplied game service program, if various competition field maps are prepared in the virtual space where the above-mentioned characters can exist, then by having the user select and download a desired field map from such plurality of competition field maps, it becomes possible for the user to participate in the game in various different maps using a character that has been developed in the game. In other words, in the case where a map that was loaded once before is cleared, the same map may be loaded again, or by loading another map, the user can play a new adventure in an unknown world. Namely, if the service program supplier such as the server 10 or the like successively prepares new maps, then the user can enjoy various role-playing games.

In this regard, the prepared maps can involve all sorts of scenarios. For example, three common scenarios are follows: (1) the players cooperate to defeat adversaries, (2) the players race against each other to acquire treasures, and (3) all the players fight each other in a battle royal until only one survivor remains.

Further, the characters participating in such map (game) grow in accordance with the progress condition of the game, with the characters being able to acquire items and the like, and in the case where such state can be saved, if the same map is utilized again, the appearing adversaries will have weakened capabilities, and because this will make possible to defeat the adversaries with a single blow or the like, the game will be less entertaining. Of course, if the adversaries are made too strong at the beginning, it will become very difficult to defeat such adversaries, and this will also make the game less entertaining.

Normally, in the case of role-playing games where characters grow (i.e., acquire increased capabilities), the adversaries that appear in accordance with the progression of scenes also have increased capabilities, but the growth of user's character capabilities does not always match the increase in the capabilities of the appearing adversaries, and when the difference between the character capabilities and the adversaries capabilities becomes large, the game can become less entertaining to the user. Further, when the starting point is returned to after having been cleared once, the capabilities of the appearing adversaries can be extremely low regardless of how high the capabilities of the characters are.

In this regard, by loading a map having a relative difficulty level matching the degree of growth of the game character, and then playing one's game character on such loaded map, it becomes possible to make the game more entertaining.

Further, in the case where the service program distribution system described in the embodiments above is used to carry out a business in which the same service is supplied between a plurality of terminals (including a server terminal) without the need of a server, it is necessary to obtain a billing of the distribution of such service program. This billing can be carried out in accordance with various fee arrangements, such as fees for each use of the program or fees based on usage time.

In this case, it can be assumed that both the server terminal 20 and the terminals 30 perform such a billing function. In other words, in the embodiments described above, distribution approval number information on the other terminals that will be supplied with the service program 41 is sent together with the service program 41 to the server terminal 20. Accordingly, this information makes it possible for the server 10 to carry out a billing of the service program 41 supplied to the server terminal 20 and the copies of the service program 41 distributed to the terminals 30 from the server terminal 20 functioning as a direct supplier.

Further, because the server terminal 20 carries out a billing of its own service program and is equipped with a distribution function for distributing the service program to the other terminals 30, the billing for the actual terminals 30 that use the service program may be carried out from each of such terminals 30. In this case, each of the terminals 30 that received a service program send a notice indicating reception of such service program (together with information such as the name of the service program) to a billing server, and then in accordance with such notice, the billing server carries out a billing for the terminals issuing such notice.

Now, in the present invention, there are many important considerations concerning the billing carried out for a service program supplied and distributed as described above, including which terminals (including the server terminal) to bill and what timing to use for such billing. Further, when a specific billing is carried out, the payment of fees can be made, for example, by payment systems that use the Internet, personal computer communication, payment networks or the like, and therefore a detailed description of such payment systems is omitted.

As described above, in the present invention, one of a plurality of terminals forms a server terminal, and because programs operated by an agent system are executed within the so-called closed space within such plurality of terminals, when programs (services) are being executed, it is possible to carry out stable processes in a secure manner without the need for the server used in the prior art.

What is claimed is:

1. A communication system which enables a plurality of terminals to receive a service program and carry out communications between terminals to execute the service program in order to receive a prescribed service, comprising:
an agent system provided in each of the terminals; and
a server terminal formed by one of the plurality of terminals;
wherein the server terminal distributes copies of the service program held in its possession to other prescribed terminals via the agent system.

2. The communication system of claim 1, wherein the prescribed terminals that received the service program from the server terminal are provided with a function to delete the service program after the prescribed service is terminated.

3. A server terminal, comprising:
a terminal equipped with an agent system, a communication function for communicating with other terminals, a program acquisition function for acquiring a service program, and a distribution function for distributing the acquired service program to the other prescribed terminals;
whereby a prescribed service is supplied to the server terminal and the other prescribed terminals when the service program is executed by the server terminal and the other prescribed terminals.

4. A server, comprising:
an agent system capable of supplying a service program to a prescribed terminal; and
an information transmission function which transmits information related to the supplied service program to the prescribed terminal at the time the service program is supplied thereto;
wherein the transmitted information makes it possible for the prescribed terminal to distribute the supplied service program to other prescribed terminals.

5. The server of claim 4, wherein the transmitted information that enables distribution includes information related to the number of terminals approved to receive the service program.

6. A server, comprising:
an agent system capable of supplying a service program to a prescribed terminal;
wherein the service program includes a server function program which makes it possible for the prescribed terminal receiving the service program to function as a server.

7. A billing system for carrying out a billing of a service program supplied from a server to a server terminal and then distributed to other terminals, comprising:
a billing function provided in the server terminal to carry out a billing of all distributed service programs based on information related to the number of terminals approved to receive the service program sent from the server to the server terminal.

8. A billing system for carrying out a billing of a service program supplied from a server to a server terminal and then distributed to other terminals, comprising:
a billing server; and
a reception notification function provided in each of the terminals to notify the billing server that the service program was received by the terminal.

9. A communication method which enables a plurality of terminals equipped with an agent system to receive a service program and carry out communications between terminals to execute the service program in order to receive a prescribed service, comprising the steps of:
establishing one of the terminals as a server terminal;
making the server terminal distribute the service program in its possession to other prescribed terminals via the agent systems thereof; and
making the prescribed terminals that received the service program from the server terminal delete the service program after the prescribed service is terminated.

10. A billing method for carrying out a billing of a service program supplied from a server to a server terminal and then distributed to other terminals, comprising the steps of:
transmitting information related to the number of terminals approved to receive the service program to the server terminal from the server; and
carrying out a billing of all distributed service programs based on the information received by the server terminal from the server.
